(19) United States
(12) Patent Application Publication
(10) Pub. No.: US 2025/0257883 A1
(43) Pub. Date: Aug. 14, 2025

(54) AIR CONDITIONER INCLUDING MOTOR DRIVING DEVICE

(71) Applicant: SAMSUNG ELECTRONICS CO., LTD., Suwon-si (KR)

(72) Inventors: Katsumi TAKENAKA, Yokohama-shi (JP); Yasuyuki YAMADA, Yokohama-shi (JP)

(73) Assignee: SAMSUNG ELECTRONICS CO., LTD., Suwon-si (KR)

(21) Appl. No.: 19/190,072

(22) Filed: Apr. 25, 2025

Related U.S. Application Data
(63) Continuation of application No. PCT/KR2023/016627, filed on Oct. 25, 2023.

(30) Foreign Application Priority Data
Oct. 26, 2022 (JP) 2022-171181

(51) Int. Cl. F24F 1/22; F24F 11/88

(52) U.S. Cl. CPC F24F 1/22; F24F 11/88

(57) ABSTRACT

An air conditioner capable of suppressing inverter loss is provided, the air conditioner may include a motor driver of a motor having phase coils not connected to each other, and the motor driver may include two inverters respectively connected to both ends of the phase coils and each having a pair of first switching devices for each phase coil, a converter configured to rectify alternating current power and convert the alternating current power into direct current power, and capacitors connected in series between output terminals of the converter and configured to divide a direct current voltage between the output terminals, wherein at least one inverter of the two inverters includes second switching devices connected between an intermediate point of the pair of first switching devices for each phase coil and an intermediate potential node of the direct current voltage formed by the capacitors.

### CROSS-REFERENCE TO RELATED APPLICATIONS

This application is a by-pass continuation of International Application No. PCT/KR 2023/016627, filed on Oct. 25, 2023, which is based on and claims priority to Japanese Patent Application No. 2022-171181, filed on Oct. 26, 2022, the disclosures of which are incorporated by reference herein in their entireties.

### BACKGROUND

### 1. Field

The present disclosure relates to an air conditioner including a motor driver.

### 2. Description of Related Art

Home appliances using motors include washing machines, dryers, air conditioners, cleaners, and refrigerators. To drive the motors, inverters are needed. In a home appliance such as an air conditioner including an inverter for driving a motor, it is necessary to improve the efficiency of the motor when the inverter operates at a low speed.

### SUMMARY

According to an aspect of the disclosure, an air conditioner includes: an outdoor heat exchange configured to perform heat exchange between a refrigerant and air; a compressor configured to intake and compress a gaseous form of the refrigerant; an expansion device configured to lower a pressure and a temperature of the refrigerant compressed during a heating operation or a cooling operation; an outdoor unit including at least a portion of a refrigerant pipe connecting the compressor to the expansion device; a motor configured to drive the compressor, the motor including a plurality of phase coils which are not connected to one another; and a motor driver configured to drive the motor, wherein the motor driver includes: a first inverter including a first switching device connected to a first end of each of the plurality of phase coils and including a pair of switches corresponding to each of the plurality of phase coils; a second inverter including a second switching device connected to a second end of each of the plurality of phase coils and including a pair of switches corresponding to each of the plurality of phase coils, a converter configured to rectify alternating current power and to convert the alternating current power into direct current power; and a plurality of capacitors configured to divide a direct current voltage across output terminals of the converter, wherein the pair of switches of the second switching device are connected to an intermediate potential node at which the direct current voltage is divided.

The second inverter may further include a plurality of third switching devices between the pair of switches of the second switching device and the intermediate potential node.

Each of the plurality of third switching devices may be configured to perform bidirectional switching.

The first inverter may further include a plurality of fourth switching devices between the pair of switches of the first switching device and the intermediate potential node.

The air conditioner may further include: memory storing one or more instructions; and at least one processor configured to execute the one or more instructions, wherein the one or more instructions, when executed by the at least one processor, cause the air conditioner to: control the first inverter and the second inverter to switch a coil mode of the motor to a star connection mode wherein respective first ends of the plurality of phase coils are connected to each other, and control the first inverter and the second inverter to switch the coil mode of the motor to an open coil mode wherein three-phase alternating current is applied to the plurality of phase coils.

The second inverter may further include a plurality of third switching devices between the pair of switches of the second switching device and the intermediate potential node, and the one or more instructions, wherein the one or more instructions, when executed by the at least one processor, cause the air conditioner to control the plurality of phase coils to be set to the star connection mode by turning off the second switching device and turning on all of the plurality of third switching devices.

The second inverter may further include a plurality of third switching devices between the pair of switches of the second switching device and the intermediate potential node, and the one or more instructions, wherein the one or more instructions, when executed by the at least one processor, may cause the air conditioner to control switching to the open coil mode by turning on only a switching device among the plurality of third switching devices corresponding to a phase coil to which a voltage is applied among the plurality of phase coils, and thereby connect the phase coil to which the voltage is applied to the intermediate potential node.

The one or more instructions, wherein the one or more instructions, when executed by the at least one processor, may cause the air conditioner to, based on the first inverter and the second inverter being in the open coil mode, apply a three-level voltage to each of the plurality of phase coils, wherein the three-level voltage includes a ±the direct current voltage level (±VDC) corresponding to a voltage across the plurality of capacitors, a ±1/2 of the direct current voltage (+1/2 VDC), and a 0 voltage level.

A voltage applied to each of the plurality of phase coils, in one period of a voltage applied to any one phase coil among the plurality of phase coils, may be a voltage of the intermediate potential node (1/2×VDC) in a first range of 0 degrees to 30 degrees and a third range of 150 degrees to 180 degrees, may be VDC in a second range of 30 degrees to 150 degrees, may be −1/2×VDC in a fourth range of 180 degrees to 210 degrees and a sixth range of 330 degrees to 360 degrees, and may be −VDC in a fifth range of 210 degrees to 330 degrees.

The second inverter may further include a plurality of third switching devices between the pair of switches of the second switching device and the intermediate potential node, the pair of switches of the first switching device may include an 11th switch and a 12th switch, the pair of switches of the second switching device may include a 21st switch and a 22nd switch, and the plurality of third switching devices connected may include a 31st switch and a 32nd switch.

The one or more instructions, wherein the one or more instructions, when executed by the at least one processor, may cause the air conditioner to: turn on the 11th switch and the 32nd switch and turn off the 12th switch and the 22nd switch in the first range and the third range, turn on the 31st switch when the 21st switch is turned off, and turn off the 31st switch when the 21st switch is turned on.

The one or more instructions, wherein the one or more instructions, when executed by the at least one processor, may cause the air conditioner to: turn on the 11th switch and the 31st switch and turn off the 12th switch and the 21st switch in the second range, turn off the 32nd switch when the 22nd switch is turned on, and turn on the 32nd switch when the 22nd switch is turned off.

The one or more instructions, wherein the one or more instructions, when executed by the at least one processor, may cause the air conditioner to: turn on the 12th switch and the 31st switch and turn off the 11th switch and the 21st switch in the fourth range and the sixth range, turn on the 32nd switch when the 22nd switch is turned off, and turn off the 32nd switch when the 22nd switch is turned on.

The one or more instructions, wherein the one or more instructions, when executed by the at least one processor, may cause the air conditioner to: turn on the 12th switch and the 32nd switch and turn off the 11th switch and the 22nd switch in the fifth range, turn off the 31st switch when the 21st switch is turned on, and turn on the 31st switch when the 21st switch is turned off.

The one or more instructions, wherein the one or more instructions, when executed by the at least one processor, may cause the air conditioner to: based on current flowing through the plurality of phase coils being less than or equal to a preset threshold value, operate the motor in the star connection mode, and based on current flowing through the plurality of phase coils exceeding the preset threshold value, operate the motor in the open coil mode.

The one or more instructions, wherein the one or more instructions, when executed by the at least one processor, may cause the air conditioner to: based on the motor operating at or below a threshold speed, operate the motor in the star connection mode, and based on the motor operating above the threshold speed, operating the motor in the open coil mode.

### BRIEF DESCRIPTION OF THE DRAWINGS

The above and other aspects and features of certain embodiments of the present disclosure will be more apparent from the following description taken in conjunction with the accompanying drawings, in which:

FIG. 1A shows an air conditioner according to one or more embodiments of the present disclosure;

FIG. 1B shows an internal structure related to flow of a refrigerant in an air conditioner according to one or more embodiments of the present disclosure;

FIG. 2A is a schematic configuration diagram of a motor driver according to one or more embodiments of the present disclosure;

FIG. 2B shows an example of equivalent circuitry when a motor is in a star connection mode, according to one or more embodiments of the present disclosure;

FIG. 3 shows an example of circuitry for a phase coil when a motor is in an open coil mode, according to one or more embodiments of the present disclosure;

FIG. 4 shows an example of an alternating current voltage applied to a phase coil, according to one or more embodiments of the present disclosure;

FIG. 5 shows an example of an ON/OFF state of each transistor in each angular range, according to one or more embodiments of the present disclosure;

FIG. 6 is a block diagram of a motor driver in an air conditioner according to one or more embodiments of the present disclosure;

FIG. 7 is a flowchart of a motor driving method in an air conditioner according to one or more embodiments of the present disclosure;

### DETAILED DESCRIPTION

The present disclosure and terms used therein are not intended to limit the technical features described in the present disclosure to particular embodiments, and it should be construed as including various modifications, equivalents, or alternatives of a corresponding embodiment.

With regard to description of drawings, similar reference numerals may be used for similar or related components.

A singular form of a noun corresponding to an item may include one item or a plurality of the items unless context clearly indicates otherwise.

As used herein, each of the expressions “A or B,” “at least one of A and B,” “at least one of A or B,” “A, B, or C,” “at least one of A, B, and C,” and “at least one of A, B, or C,” may include one or all possible combinations of the items listed together with a corresponding expression among the expressions.

The term “and/or” includes any and all combinations of one or more of a plurality of associated listed items.

It will be understood that the terms “1^{st}”, “2^{nd}”, first”, “second”, etc., may be used only to distinguish one component from another, not intended to limit the corresponding component in other aspects (e.g., importance or order).

It is said that one (e.g., first) component is “coupled” or “connected” to another (e.g., second) component, with or without the terms “functionally” or “communicatively”. When referenced, it means that one component can be connected to the other component directly (e.g., by wire), wirelessly, or through a third component.

It will be understood that when the terms “includes,” “comprises,” “including,” and/or “comprising,” when used in this specification, specify the presence of stated features, figures, steps, operations, components, members, or combinations thereof, but do not preclude the presence or addition of one or more other features, figures, steps, operations, components, members, or combinations thereof.

An expression that one component is “connected”, “coupled”, “supported”, or “in contact” with another component includes a case in which the components are directly “connected”, “coupled”, “supported”, or “in contact” with each other and a case in which the components are indirectly “connected”, “coupled”, “supported”, or “in contact” with each other through a third component.

It will also be understood that when one component is referred to as being “on” or “over” another component, it can be directly on the other component or intervening components may also be present.

Hereinafter, embodiments of the present disclosure will be described in detail with reference to the accompanying drawings such that one of ordinary skill in the art to which the present disclosure belongs can easily embody the embodiments. However, the present disclosure may be embodied in many different forms and should not be construed as being limited to the embodiments set forth herein. In the drawings, portions that are irrelevant to the descriptions may be not shown in order to clarify the embodiments of the present disclosure, and throughout the specification, similar portions are assigned similar reference numerals.

A home appliance may include an electrical appliance and machine used in a home. According to one or more embodiments of the present disclosure, the home appliance may include a device that is fixedly placed within a home or a device that is movable within a home. Here, the home may mean not only a house but also an indoor space such as an office. For example, the home appliance may include a television, a digital video disk (DVD) player, an audio system, a refrigerator, an air conditioner, a cleaner, an oven, a microwave oven, a washing machine, an air purifier, a set-top box, a home automation control panel, a security control panel, a media box (e.g., Samsung HomeSync™), a game console, an electronic dictionary, an electronic key, a camcorder, an electronic picture frame, a speaker, an e-book reader, a desktop PC, a laptop PC, a netbook computer, a workstation, a server, a PDA, a portable multimedia player (PMP), an MP3 player, a medical device, a camera, and the like. The home appliance according to one or more embodiments of the present disclosure may particularly include a home appliance that drives a motor. According to one or more embodiments of the present disclosure, the home appliance driving the motor may include, but is not limited thereto, a cleaner, a cordless cleaner, a washing machine, a dryer, a refrigerator, an air purifier, a dishwasher, an electric fan, and an air conditioner.

An air conditioner according to one or more embodiments of the present disclosure may absorb heat inside an air-conditioned space (hereinafter, referred to as “indoor”) to be air-conditioned and emit heat outside the air-conditioned space (hereinafter, referred to as “outdoor”) to cool the air-conditioned space. Also, the air conditioner may absorb heat outdoor and emit heat indoor to heat an indoor space.

The air conditioner may include one, two, or more outdoor units installed outdoor, and one, two, or more indoor units installed indoor. An outdoor unit may be electrically connected to an indoor unit. For example, a user may input information (or a command) for controlling the indoor unit through a user interface, and the outdoor unit may operate in response to a user input from the indoor unit.

The outdoor unit may be fluidically connected to the indoor unit through a refrigerant pipe.

The outdoor unit may be installed outdoor. The outdoor unit may perform heat exchange between a refrigerant and outside air by using a phase change (for example, evaporation or condensation) of the refrigerant. At this time, the heat exchange may occur through an outdoor heat exchanger included in the outdoor unit. For example, while a refrigerant is condensed in the outdoor unit, the refrigerant may emit heat to outside air. While a refrigerant is evaporated in the outdoor unit, the refrigerant may absorb heat from outside air.

The indoor unit may be installed indoor. The indoor unit may perform heat exchange between a refrigerant and indoor air by using a phase change (for example, evaporation or condensation) of the refrigerant. At this time, the heat exchange may occur through an indoor heat exchanger included in the indoor unit. For example, while a refrigerant is evaporated in the indoor unit, the refrigerant may absorb heat from indoor air and an indoor space may be cooled. While a refrigerant is condensed in the indoor unit, the refrigerant may emit heat to indoor air and the indoor space may be heated. The air conditioner may include a compressor, the outdoor heat exchanger, an expansion device, and the indoor heat exchanger. The air conditioner may include a refrigerant pipe connecting the compressor, the outdoor heat exchanger, the expansion device, and the indoor heat exchanger to each other.

A refrigerant may circulate through the refrigerant pipe in the order of the compressor, the outdoor heat exchanger, the expansion device, and the indoor heat exchanger or in the order of the compressor, the indoor heat exchanger, the expansion device, and the outdoor heat exchanger.

The compressor, the outdoor heat exchanger, and the expansion device may be positioned in the outdoor unit. In the indoor unit, the indoor heat exchanger may be installed. A position of the expansion device is not limited to the outdoor unit, and the expansion device may be positioned in the indoor unit as necessary.

The compressor may intake a refrigerant gas through an inlet and compress the refrigerant gas. The compressor may discharge a high-temperature and high-pressure refrigerant gas through an outlet.

The air conditioner may further include a flow path switching valve. The flow path switching valve may include, for example, a 4-way valve. The flow path switching valve may switch a circulation path of a refrigerant depending on a driving mode (for example, a cooling operation or a heating operation) of the air conditioner. The flow path switching valve may be connected to the outlet of the compressor.

The air conditioner may include an accumulator. The accumulator may be connected to the inlet of the compressor. A low-temperature and low-pressure refrigerant evaporated in the indoor heat exchanger or the outdoor heat exchanger may enter the accumulator. When a refrigerant being a mixture of a refrigerant liquid and a refrigerant gas enters the accumulator, the accumulator may separate the refrigerant liquid from the refrigerant gas and provide the refrigerant gas from which the refrigerant liquid has been separated to the compressor.

In the outdoor heat exchanger, heat exchange between a refrigerant and outside air may occur. For example, during a cooling operation, in the outdoor heat exchange, a high-pressure and high-temperature refrigerant may be condensed, and while the refrigerant is condensed, the refrigerant may emit heat to outside air. During a heating operation, in the outdoor heat exchange, a low-pressure and low-temperature refrigerant may be evaporated, and while the refrigerant is evaporated, the refrigerant may absorb heat from outside air.

An outdoor fan may be provided around the outdoor heat exchanger. The outdoor fan may blow outside air to the outdoor heat exchanger to facilitate heat exchange between a refrigerant and outside air.

The expansion device may lower temperature and pressure of a refrigerant condensed in the outdoor heat exchanger during a cooling operation, and during a heating operation, the expansion device may lower temperature and pressure of a refrigerant condensed in the indoor heat exchanger.

The expansion device may lower temperature and pressure of the refrigerant by using, for example, a throttling effect. The expansion device may include an orifice capable of reducing a cross-sectional area of a flow path. The refrigerant passed through the orifice may be lowered in temperature and pressure.

The expansion device may be implemented as an electronic expansion valve capable of adjusting an opening rate (a ratio of a cross-sectional area of the flow path of the valve in a partially open state with respect to a cross-sectional area of the flow path of the valve in a fully open state). An amount of a refrigerant passing through the expansion device may be controlled depending on an opening rate of the electronic expansion valve.

The indoor unit of the air conditioner may include a housing, a blower that circulates air into or out of the housing, and the indoor heat exchanger that exchanges heat with air entered the housing.

The housing may include an inlet. Indoor air may enter the housing through the inlet.

The indoor unit of the air conditioner may include a filter that filters a foreign material from air entered the housing through the inlet.

The housing may include an outlet. Air flowing inside the housing may be discharged to outside of the housing through the outlet.

The indoor unit of the air conditioner may include an airflow guide for guiding a direction of air to be discharged through the outlet. For example, the airflow guide may include a blade positioned on the outlet. For example, the airflow guide may include, but is not limited thereto, an auxiliary fan for adjusting a discharge airflow. However, the airflow guide may be omitted.

The indoor unit of the air conditioner may include a flow path connecting the inlet to the outlet. The flow path may allow air sucked into the inlet to flow to the outlet. On the flow path, the blower and the indoor heat exchanger may be positioned.

The blower may include an indoor fan and a fan motor. For example, the indoor fan may include an axial flow fan, a mixed flow fan, a cross flow fan, and a centrifugal fan.

The indoor heat exchanger may be positioned between the blower and the outlet or between the inlet and the blower. The indoor heat exchanger may absorb heat from air entered through the inlet or transfer heat to air entered through the inlet. The indoor heat exchanger may include a heat exchange pipe through which a refrigerant flows and a heat exchange fin provided to increase a heat transfer area.

The indoor unit of the air conditioner may include a drain tray positioned below the indoor heat exchanger to collect condensed water generated in the indoor heat exchanger. Condensed water accommodated in the drain tray may be discharged to the outside through a drain hose. The drain tray may support the indoor heat exchanger.

The indoor unit of the air conditioner may include a first controller that controls components of the indoor unit, including the blower, etc. The outdoor unit of the air conditioner may include a second controller that controls components of the outdoor unit, including the compressor, etc. The first controller may communicate with the second controller.

The first controller may obtain a user input through a user device including a mobile device, etc. or a remote controller, and the indoor unit may include a communication unit or an infrared receiver capable of communicating with the user device or the remote controller.

The first controller may control the components of the indoor unit, including the blower, etc. in response to a received user input. The first controller may transmit information about the received user input to the second controller of the outdoor unit. The second controller may control the components of the outdoor unit, including the compressor, etc., based on the information about the user input received from the indoor unit.

The first controller and the second controller may include a processor and memory. The first controller and the second controller may provide control signals to the compressor, the flow path switching valve, the expansion device, the outdoor fan, and the blower to drive the air conditioner in response to a user input.

The indoor unit of the air conditioner may include a display that displays operation information of the air conditioner. The display may receive information about an operation of the air conditioner from the first controller and display information corresponding to the received information.

The display may include an indicator that displays an operation mode of the air conditioner, selected by a user, or a power on/off state of the indoor unit. The indicator may include, for example, a Liquid Crystal Display (LCD) panel, a Light Emitting Diode (LED) panel, and a plurality of LEDs.

In an air conditioner, because a compressor often operates at a low speed, improving efficiency of a compressor motor in a low-speed operation region may greatly contribute to improving energy saving performance of the air conditioner. For example, a motor driver for an open coil motor having a plurality of phase coils not connected to each other in an inverter may be proposed. Also, the motor driver may include a first inverter connected to one ends of the phase coils and controlling current flow to the one ends of the phase coils, a second inverter connected to other ends of the phase coils and controlling current flow to the other ends of the phase coils, a switch connected between the other ends of the phase coils, and a controller that controls opening and closing of the switch and operations of the first and second inverters. Also, while the motor operates, the controller may close the switch and drive only the first inverter.

According to the present disclosure, an air conditioner or a refrigerator including a motor driver capable of suppressing inverter loss may be provided.

In the motor driver, inverter loss is large when two inverters operate in two levels, and therefore, this needs to be improved. The present disclosure may suppress inverter loss during a two-level inverter operation.

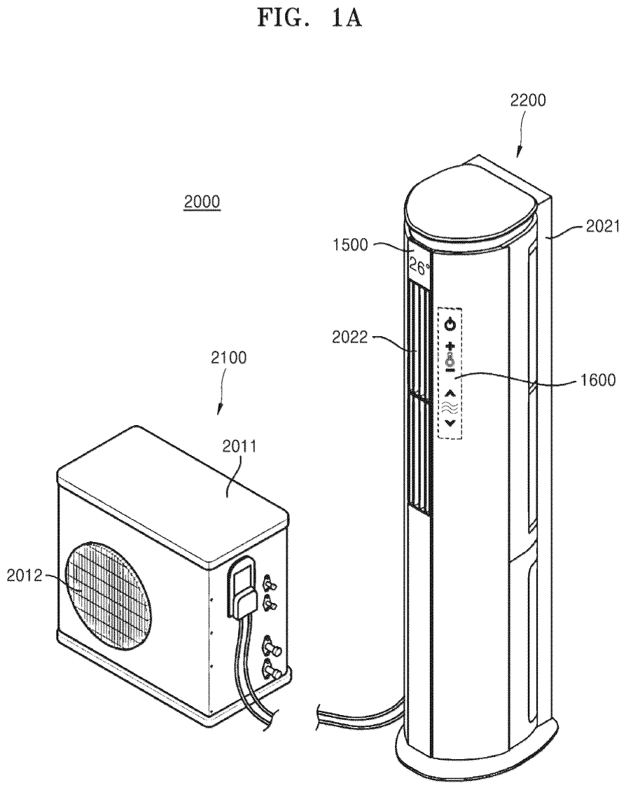

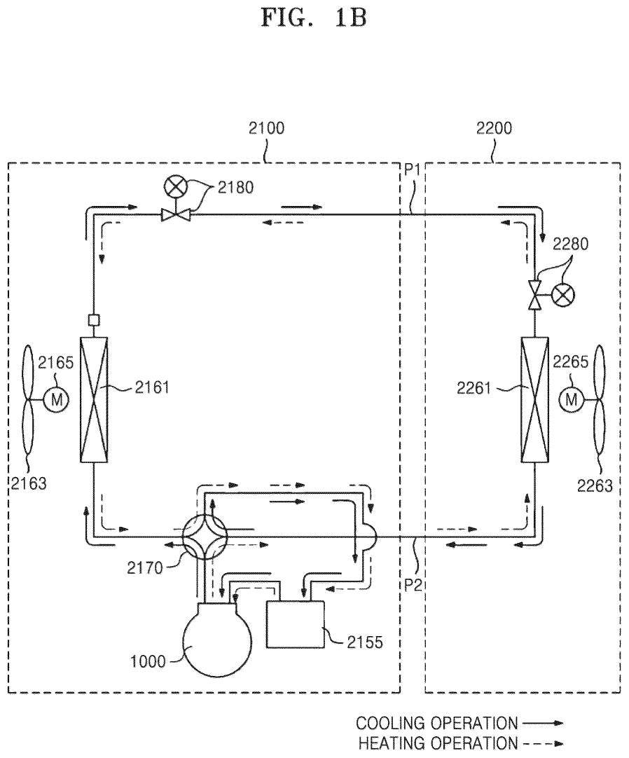

FIG. 1A shows an air conditioner according to one or more embodiments of the present disclosure.

Referring to FIG. 1A, an air conditioner 2000 may include an outdoor unit 2100 provided in an outdoor space and including an outdoor heat exchanger that performs heat exchange between outside air and a refrigerant, and an indoor unit 2200 provided in an indoor (home) space and including an indoor heat exchanger that performs heat exchange between indoor air and a refrigerant.

The outdoor unit 2100 may include an outdoor unit main body 2011 forming an appearance of the outdoor unit 2100, and an outdoor unit fan 2012 provided in one side of the outdoor unit main body 2011 to discharge heat-exchanged air.

The indoor unit 2200 may include an indoor unit main body 2021 forming an appearance of the indoor unit 2200, an indoor unit outlet 2022 provided in a front side of the indoor unit main body 2021 to discharge heat-exchanged air, an input interface 1600 that receives an operation command for the air conditioner 2000 from a user, and an output interface 1500 that displays operation information of the air conditioner 2000.

FIG. 1B shows an internal structure related to flow of a refrigerant in an air conditioner according to one or more embodiments of the present disclosure.

Referring to FIG. 1B, the air conditioner 2000 may include the outdoor unit 2100, the indoor unit 2200, a liquid pipe P1 which connects the outdoor unit 2100 to the indoor unit 2200 and through which a liquid refrigerant moves, and a gas pipe P2 used as a passage through which a gaseous refrigerant moves, wherein the liquid pipe P1 and the gas pipe P2 may extend into the outdoor unit 2100 and the indoor unit 2200.

The outdoor unit 2100 may include a compressor 1000 that compresses a refrigerant, an outdoor heat exchanger 2161 that performs heat exchange between outside air and the refrigerant, a four-way valve 2170 that selectively guides the refrigerant compressed in the compressor 1000 to any of the outdoor heat exchanger 2161 or the indoor unit 2200 depending on whether a heating or cooling operation is performed, an outdoor expansion valve 2180 that decompresses the refrigerant guided to the outdoor heat exchanger 2161 during a heating operation, and an accumulator 2155 that prevents a liquid refrigerant not yet evaporated from flowing into the compressor 1000.

The compressor 1000 may compress a low-pressure gaseous refrigerant to a high pressure by using rotational power of a motor 1100 for the compressor 1000 rotating by receiving electric energy from an external power source.

The four-way valve 2170 may guide, during a cooling operation, a refrigerant compressed in the compressor 2150 to the outdoor heat exchanger 2161, and during a heating operation, the four-way valve 2170 may guide a refrigerant compressed in the compressor 1000 to the indoor unit 2200.

The outdoor heat exchanger 2161 may condense, during a cooling operation, a refrigerant compressed in the compressor 1000, and during a heating operation, the outdoor heat exchanger 2161 may evaporate a refrigerant decompressed in the indoor unit 2200. The outdoor heat exchanger 2161 may include an outdoor heat exchanger cooling fin for improving heat exchange efficiency between a refrigerant and outside air by increasing a surface area where an outdoor heat exchanger refrigerant pipe through which the refrigerant passes comes into contact with the outside air, an outdoor fan 2163 for blowing outside air to the outdoor heat exchanger 2161, and an outdoor fan motor 2165 for transmitting rotational power to the outdoor fan 2163.

The outdoor expansion valve 2180 may not only decompress a refrigerant during a heating mode but also regulate an amount of refrigerant provided to the outdoor heat exchanger 2161 to ensure sufficient heat exchange in the outdoor heat exchanger 2161. More specifically, the outdoor expansion valve 2180 may decompress a refrigerant by a throttling action of a refrigerant by which a refrigerant passing through a narrow flow path is reduced in pressure without exchanging heat with outside. The outdoor expansion valve 2180 may adopt an electronic valve of which an opening degree is adjustable to regulate an amount of a refrigerant passing through the outdoor expansion valve 2180.

The indoor unit 2200 may include an indoor heat exchanger 2261 that performs heat exchange between indoor air and a refrigerant, and an indoor expansion valve 2280 that decompresses a refrigerant to be provided to the indoor heat exchanger 2261 during a cooling operation.

The indoor heat exchanger 2261 may evaporate a low-pressure refrigerant during a cooling operation of the air conditioner 2000, and during a heating operation, the indoor heat exchanger 2261 may condense a high-pressure gaseous refrigerant. The indoor heat exchanger 2261 may include, like the outdoor heat exchanger 2161 of the outdoor unit 2100, an indoor heat exchanger refrigerant pipe through which a refrigerant passes, an indoor heat exchanger cooling fin for improving heat exchange efficiency between the refrigerant and indoor air, an indoor fan 2263 for blowing air heat-exchanged with the refrigerant in the indoor heat exchanger 2261 to an indoor space, and an indoor fan motor 2265 for transmitting rotational power to the indoor fan 2263.

The indoor expansion valve 2280 may regulate, in addition to decompressing a refrigerant by a throttling action, an amount of a refrigerant that is to be provided to the outdoor heat exchanger 2161 such that sufficient heat exchange occurs in the indoor heat exchanger 2261. The indoor expansion valve 2280 may adopt an electronic valve of which an opening degree is adjustable to regulate an amount of a refrigerant passing through the indoor expansion valve 2280.

Hereinafter, flow of a refrigerant according to an operation mode of the air conditioner 200, that is, a cooling or heating operation will be described.

While the air conditioner 2000 operates in a cooling operation, a refrigerant may be compressed to high pressure by the compressor 1000 of the outdoor unit 2100. While the refrigerant is compressed, both pressure and temperature of the refrigerant may increase.

The compressed refrigerant may be guided to the outdoor heat exchanger 2161 by the four-way valve 2170. The refrigerant guided to the outdoor heat exchanger 2161 may be condensed in the outdoor heat exchanger 2161, and while the refrigerant is condensed, heat exchange between the refrigerant and outside air may occur. More specifically, while the refrigerant changes from a gaseous state to a liquid state, the refrigerant may release, to the outside, energy (latent heat) equal to a difference between internal energy of the refrigerant in the gaseous state and internal energy of the refrigerant in the liquid state. The condensed liquid refrigerant in the liquid state may pass through the outdoor expansion valve 2180 and then be provided to the indoor unit 2200 via the liquid pipe P1.

The liquid refrigerant provided to the indoor unit 2200 may be reduced in temperature and pressure in the indoor expansion valve 2280 provided on the liquid pipe P1. More specifically, the indoor expansion valve 2280 may decompress a refrigerant by a throttling action of a refrigerant by which a fluid passing through a narrow flow path is reduced in pressure without exchanging heat with outside.

The indoor expansion valve 2280 may adopt an electronic valve of which an opening degree is adjustable in order to regulate an amount of a refrigerant that flows into the indoor heat exchanger 2261.

The decompressed liquid refrigerant may be evaporated in the indoor heat exchanger 2261, and while the refrigerant is evaporated, heat exchange between the refrigerant and indoor air may occur. More specifically, while the refrigerant changes from a liquid state to a gaseous state, the refrigerant may absorb, from indoor air, energy (latent heat) equal to a difference between internal energy of the refrigerant in the gaseous state and internal energy of the refrigerant in the liquid state. As such, during a cooling operation, the air conditioner 2000 may cool indoor air by using heat exchange between a refrigerant and the indoor air, which occurs in the indoor heat exchanger 2261, in other words, by using the refrigerant absorbing latent heat from the indoor air.

The evaporated gaseous refrigerant may be provided to the outdoor unit 2100 through the gas pipe P2 and to the accumulator 2155 via the four-way valve 2170. In the accumulator 2155, the refrigerant may be separated into a liquid refrigerant not yet evaporated and an evaporated gaseous refrigerant, and the gaseous refrigerant may be again provided to the compressor 1000.

The gaseous refrigerant provided to the compressor 1000 may be compressed in the compressor 1000, and accordingly, refrigerant circulation as described above may be repeated.

To summarize heat exchange by a refrigerant in the air conditioner 2000 operating in a cooling operation, the refrigerant may absorb heat energy of indoor air in the indoor heat exchanger 2261 of the indoor unit 2200 and release the heat energy to the outside in the outdoor heat exchanger 2161 of the outdoor unit 2100, thereby transferring indoor heat energy to the outside.

While the air conditioner 200 operates in a heating operation, a refrigerant may be compressed to high pressure by the compressor 1000 of the outdoor unit 2100, and temperature and pressure of the refrigerant may increase.

The compressed refrigerant may pass through the four-way valve 2170 and then be guided to the indoor unit 2200 along the gas pipe P2. The refrigerant may be condensed in the indoor heat exchanger 2261, and while the refrigerant is condensed, heat exchange between the refrigerant and indoor air may occur. More specifically, while the refrigerant changes from a gaseous state to a liquid state, the refrigerant may release, to the indoor space, energy (latent heat) equal to a difference between internal energy of the gaseous state and internal energy of the liquid state. As such, in the heating mode, the air conditioner 2000 may heat indoor air by using heat exchange between a refrigerant and the indoor air, which occurs in the indoor heat exchanger 2261, that is, by using a refrigerant releasing latent heat.

The condensed liquid refrigerant may pass through the indoor expansion valve 2280 and then be provided to the outdoor unit 2100 along the liquid pipe P1. The liquid refrigerant provided to the outdoor unit 2100 may be decompressed in the outdoor expansion valve 2180 provided on the liquid pipe P1 and temperature of the refrigerant may also be lowered. The outdoor expansion valve 2180 may adopt an electronic valve of which an opening degree is adjustable in order to regulate an amount of a refrigerant that flows into the outdoor heat exchanger 2161 which will be described below.

The decompressed liquid refrigerant may be evaporated in the outdoor heat exchanger 2161, and while the refrigerant is evaporated, heat exchange between the refrigerant and outdoor air may occur. More specifically, while the refrigerant changes from the liquid state to a gaseous state, the refrigerant may absorb, from outside air, energy (latent heat) equal to a difference between internal energy of the refrigerant in the gaseous state and internal energy of the refrigerant in the liquid state.

The gaseous refrigerant evaporated in the outdoor heat exchanger 2161 may be provided to the accumulator 2155 through the four-way valve 2170. In the accumulator 2155, the refrigerant may be separated into a liquid refrigerant not yet evaporated and an evaporated gaseous refrigerant, and the gaseous refrigerant may be provided to the compressor 1000.

The gaseous refrigerant provided to the compressor 1000 may be compressed in the compressor 1000, and accordingly, circulation of the refrigerant may be repeated.

To summarize heat exchange by a refrigerant in the air conditioner 2000 operating in a heating operation, the refrigerant may absorb heat energy of outside air in the outdoor heat exchanger 2161 of the outdoor unit 2100 and release heat energy to the indoor space in the indoor heat exchanger 2261 of the indoor unit 2200, thereby transferring heat energy of the outside to the indoor space.

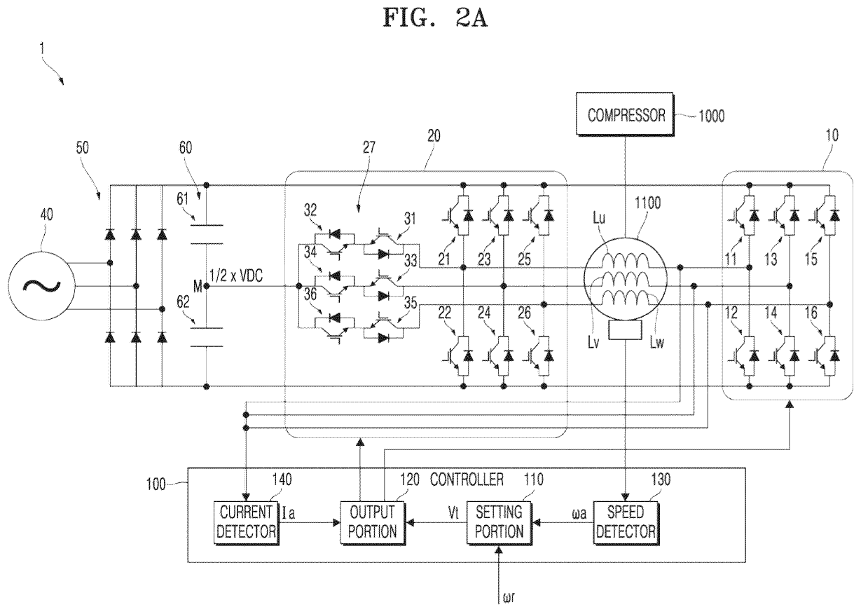

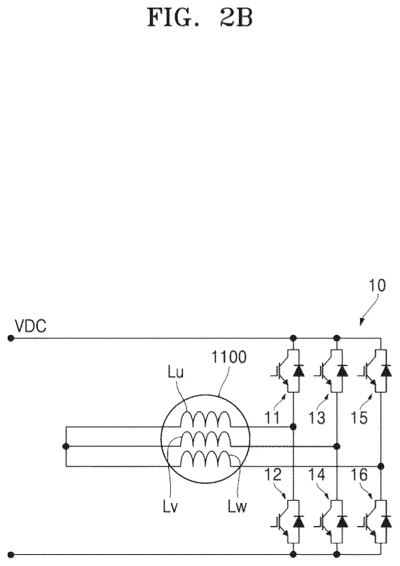

FIG. 2A is a schematic configuration diagram of a motor driver 1 according to one or more embodiments of the present disclosure.

The motor driver 1 may be a device that controls driving of a motor used in, for example, a cleaner, a codeless cleaner, a washing machine, a dryer, an air purifier, a dishwasher, or an electric fan (including a circulator), or a motor 1100 for the compressor 1000, used in a refrigerator or an air conditioner.

The compressor 1000 may be a device that performs a suction operation for filling a cylinder with refrigerant, a compression operation for compressing the refrigerant inside the cylinder, and a discharge operation for discharging the compressed refrigerant to outside of the compressor 1000. A compression mechanism of the compressor 1000 is not particularly limited, and may be, for example, a rotary type, a reciprocating type, or a scroll type.

The motor 1100 may be, for example, a Permanent Magnet Synchronous Motor (PMSM) or an induction motor. In one or more embodiments, the motor 1100 may be an Open-Windings Motor configured with a plurality of (three in the present embodiment) phase coils (Lu, Lv, and Lw in the present embodiment) that are not connected to each other. However, this is only an example, and the type of the motor 1100 is not particularly limited thereto. Throughout the present disclosure, the plurality of phase coils Lu, Lv, and Lw are also referred to as a first coil, a second coil, and a third coil.

The motor driver 1 may include a first inverter 10 connected to one ends of the plurality of phase coils Lu, Lv, and Lw and having a pair of transistors for each phase coil, and a second inverter 20 connected to other ends of the plurality of phase coils Lu, Lv, and Lw and having a pair of transistors for each phase coil.

Also, the motor driver 1 may include an input power source 40, a converter 50, a smoothing capacitor 60, and a controller 100 for controlling operations of the first inverter 10 and the second inverter 20. The controller 100 may include a processor for controlling overall operations of the motor driver 1 and/or the air conditioner 2000.

The first inverter 10 may be a circuitry for converting a direct current voltage VDC into an alternating current voltage and supplying the alternating current voltage to the motor 1100. The first inverter 10 may be configured with a bridge circuitry and may be provided with six transistors 11, 12, 13, 14, 15, and 16 as examples of a plurality of sets of first switching devices. The six transistors 11, 12, 13, 14, 15, and 16 may be switches that are controllable by gate signals, and for example, the six transistors 11, 12, 13, 14, 15, and 16 in the present disclosure may be replaced by devices that perform switching control by gate signals, such as a field effect transistor (FET), an insulated gate bipolar mode transistor (IGBT), a gate turn-off thyristor (GTO), a metal oxide semiconductor field effect transistor (MOSFET), etc. Throughout the present disclosure, the six transistors 11, 12, 13, 14, 15, and 16 as the plurality of sets of first switching devices are also referred to as an 11th switch, a 12th switch, a 13th switch, a 14th switch, a 15th switch, and a 16th switch, respectively.

In one or more embodiments of the present disclosure, the first inverter 10 may include a pair of transistors for each of the plurality of phase coils Lu, Lv, and Lw of the motor 1100. More specifically, the first inverter 10 may include the transistor 11 and the transistor 12 for the phase coil Lu, the transistor 13 and the transistor 14 for the phase coil Lv, and the transistor 15 and the transistor 16 for the phase coil Lw. Emitters of the transistors 11, 13, and 15 and collectors of the transistors 12, 14, and 16 may be respectively connected to the plurality of phase coils Lu, Lv, and Lw of the motor 1100. Also, collectors of the transistors 11, 13, and 15 may be connected to a positive line of the power source, and emitters of the transistors 12, 14, and 16 may be connected to a negative (ground) line of the power source.

The second inverter 20 may be a three-level inverter of a bidirectional switch type, and may include six transistors 21 to 26 as examples of a plurality of sets of second switching devices and a bidirectional switch portion 27. The six transistors 21, 22, 23, 24, 25, and 26 may be switches that are controllable by gate signals, and for example, the six transistors 21, 22, 23, 24, 25, and 26 in the present disclosure may be replaced by devices that perform switching control by gate signals, such as a field effect transistor (FET), an insulated gate bipolar mode transistor (IGBT), a gate turn-off thyristor (GTO), a metal oxide semiconductor field effect transistor (MOSFET), etc. Throughout the present disclosure, the six transistors 21, 22, 23, 24, 25, and 26 as the plurality of sets of first switching devices are also referred to as a 21st switch, a 22nd switch, a 23rd switch, a 24th switch, a 25th switch, and a 26th switch, respectively. The transistors 21 to 26 may configure a pair of transistors for each of the plurality of phase coils Lu, Lv, and Lw of the motor 1100, and may be configured with the transistor 21 and the transistor 22 for the phase coil Lu, the transistor 23 and the transistor 24 for the phase coil Lv, and the transistor 25 and the transistor 26 for the phase coil Lw. Emitters of the transistors 21, 23, and 25 and collectors of the transistors 22, 24, and 26 may be respectively connected to the plurality of phase coils Lu, Lv, and Lw of the motor 1100. Also, collectors of the transistors 21, 23, and 25 may be connected to the positive line of the power source, and emitters of the transistors 22, 24, and 26 may be connected to the negative (ground) line of the power source.

The bidirectional switch portion 27 may include six transistors 31 to 36 as examples of third switching devices. The six transistors 31, 32, 33, 34, 35, and 36 may be switches that are controllable by gate signals, and for example, the six transistors 31, 32, 33, 34, 35, and 36 in the present disclosure may be replaced by devices that perform switching control by gate signals, such as a field effect transistor (FET), an insulated gate bipolar mode transistor (IGBT), a gate turn-off thyristor (GTO), a metal oxide semiconductor field effect transistor (MOSFET), etc. Throughout the present disclosure, the six transistors 31, 32, 33, 34, 35, and 36 as the plurality of sets of third switching devices are also referred to as a 31st switch, a 32nd switch, a 33rd switch, a 34th switch, a 35th switch, and a 36th switch, respectively.

The transistors 31 to 36 may configure a pair of transistors for each of the plurality of phase coils Lu, Lv, and Lw of the motor 1100, and may be configured with the transistor 31 and the transistor 32 for the phase coil Lu, the transistor 33 and the transistor 34 for the phase coil Lv, and the transistor 35 and the transistor 36 for the phase coil Lw. Emitters of the transistors 31, 33, and 35 may be respectively connected to collectors of the transistors 32, 34, and 36. Also, collectors of the transistors 31, 33, and 35 may be respectively connected to the plurality of phase coils Lu, Lv, and Lw of the motor 1100, and the collectors of the transistors 32, 34, and 36 may be connected to an intermediate potential node M which will be described below.

The transistors 11 to 16 of the first inverter 10, and the transistors 21 to 26 and the transistors 31 to 36 of the second inverter 20 may use power transistors of various structures, such as a bipolar type, a field effect type, and a MOS type, as described above. Also, all the transistors may perform on/off switching operations according to a control signal output from the controller 100. Therefore, the first inverter 10 and the second inverter 20 may convert a direct current voltage VDC into an alternating current voltage and supply the converted alternating current voltage to the motor 1100 to drive the motor 1100.

The converter 50 may be connected to the alternating current power source 40 and convert an alternating current voltage of the alternating current power source 40 into a direct current voltage VDC. The converter 50 may be, but is not limited thereto, configured with diode devices, and at least a part of the converter 50 may be a controllable switching device such as a thyristor, an IGBT, or a GTO.

The smoothing capacitor 60 may be connected to a direct current output terminal of the converter 50 and smooth a direct current voltage VDC which is an output of the converter 50. The smoothing capacitor 60 may include a first capacitor 61 and a second capacitor 62 connected in series between output terminals of the converter 50. The first capacitor 61 and the second capacitor 62 may divide a direct current voltage VDC which is an output of the converter 50 by half. A node of the voltage division may be the intermediate potential node M.

The controller 100 may include a setting portion 110 for setting a control value Vt, and an output portion 120 that outputs a signal for driving the motor 1100 by using the control value Vt set by the setting portion 110 and a speed wa of the motor 1100. Also, the controller 100 may include a speed detector 130 for detecting a speed wa of the motor 1100, and a current detector 140 for detecting current la that is supplied to the motor 1100.

The setting portion 110 may calculate a control value Vt, based on a speed instruction wr output to the controller 100 from a higher-level control unit including the controller 100, for example, a control unit that controls overall operations of a refrigerator, and an actual speed wa of the motor 1100 detected by the speed detector 130. The setting portion 110 may output the calculated control value Vt to the output portion 120.

As such, the controller 100 may be configured as a speed feedback control system such that a speed instruction wr is identical to a speed wa of the motor 1100.

The output portion 120 may output a signal for driving the motor 1100 based on a position of a rotor of the motor 1100, and perform pulse width modulation (PWM) chopping by using a PWM waveform. The PWM chopping may include turning on/off a signal for driving the motor 1100. By turning on/off the signal, current that is supplied to each phase of the motor 1100 may be controlled according to a duty ratio, and therefore, an output torque may be controlled.

The speed detector 130 may detect a speed ωa (rpm) of the motor 1100 based on a signal according to a rotation angle of the motor 1100 output from an encoder or resolver installed in the motor 1100. However, the speed detector 130 may detect a speed ωa (rpm) of the motor 1100 by estimating a relationship between a reference voltage and a waveform of an induced voltage of the plurality of phase coils Lu, Lv, and Lw of the motor 1100 by using a value of current flowing through each of the phase coils Lu, Lv, and Lw, obtained from the current detector 140, and identifying a change in position of the rotor per a unit time.

The current detector 140 may include a U-phase current detector for detecting current actually flowing through the phase coil Lu, a V-phase current detector for detecting current actually flowing through the phase coil Lv, and a W-phase current detector for detecting current actually flowing through the phase coil Lw. The U-phase current detector, the V-phase current detector, and the W-phase current detector may detect a value of current flowing through each phase coil from a voltage generated at both ends of a so-called shunt resistor connected to each of the phase coils Lu, Lv, and Lw.

In the motor driver 1 configured as described above, the controller 100 may control the first inverter 10 and the second inverter 20 to switch a coil mode of the motor 1100 between a star connection mode in which one ends of the plurality of phase coils Lu, Lv, and Lw are connected to each other and an open coil mode that applies 3-phase alternating current to each of the plurality of phase coils Lu, Lv, and Lw by operating the two inverters in cooperation with each other-controlling the inverters respectively.

FIG. 2B shows an example of an equivalent circuitry when a motor is in the star connection mode according to one or more embodiments of the present disclosure.

The processor of the controller 100 may set the plurality of phase coils Lu, Lv, and Lw to the star connection mode by always turning off all the six transistors 21, 22, 23, 24, 25, and 26 of the second inverter 20 and always turning on all the six transistors 31, 32, 33, 34, 35, and 36. In other words, because the transistors 31, 32, 33, 34, 35, and 36 of the second inverter 20 are connected to the intermediate potential node M, by turning off all the transistors 21, 22, 23, 24, 25, 26 and turning on all the transistors 31, 32, 33, 34, 35, and 36, the other ends of the plurality of phase coils Lu, Lv, and Lw may be short-circuited and a neutral point voltage of 1/2×VDC may be applied thereto. In this state, the processor of the controller 100 may switch the transistors 11, 12, 13, 14, 15, and 16 of the first inverter 10 to form an equivalent circuitry shown in FIG. 2 and operate the motor 1100 in the star connection mode. In the present disclosure, the neutral point voltage may be interchangeably referred to as 1/2×VDC which is a voltage of the intermediate potential node M.

In addition, the processor of the controller 100 may perform switching control on some of the transistors 31, 32, 33, 34, 35, and 36 according to the phase coil Lu, Lv, or Lw to which a voltage is applied, instead of turning on all the transistors 31, 32, 33, 34, 35, and 35 of the bidirectional switch portion 27 of the second inverter 20, to connect the other end of the phase coil Lu, Lv, or Lw to the neural point voltage. For example, while current is supplied to the phase coils Lu and Lv, the processor of the controller 100 may turn on the transistors 31, 32, 33, and 34 and turn off the transistors 35 and 36.

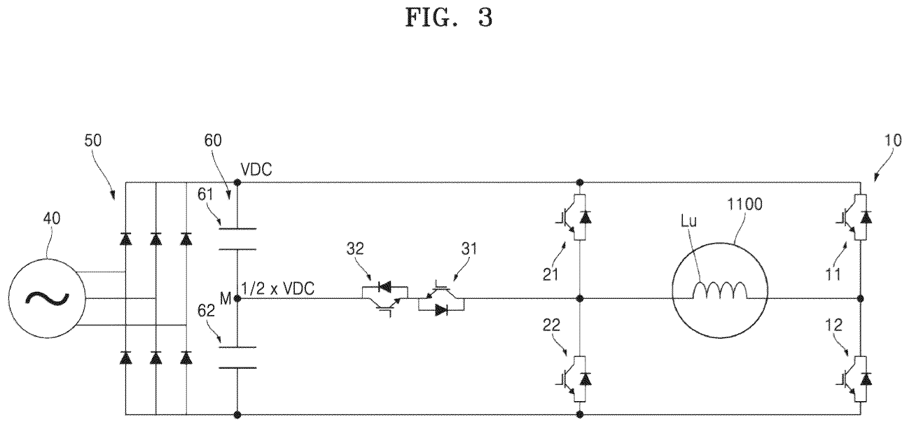

FIG. 3 shows an example of a circuitry for the phase coil Lu when the motor 1100 is in the open coil mode according to one or more embodiments of the present disclosure.

Hereinafter, an operation of the motor 1100 in the open coil mode will be described as an example of the phase coil Lu.

The transistors 11 and 12 of the first inverter 10 may be connected to one end of the phase coil Lu, and the transistors 21 and 22 of the second inverter 20 may be connected to another end of the phase coil Lu. Also, the transistors 31 and 32 may be connected between the other end of the phase coil Lu and the intermediate potential node M.

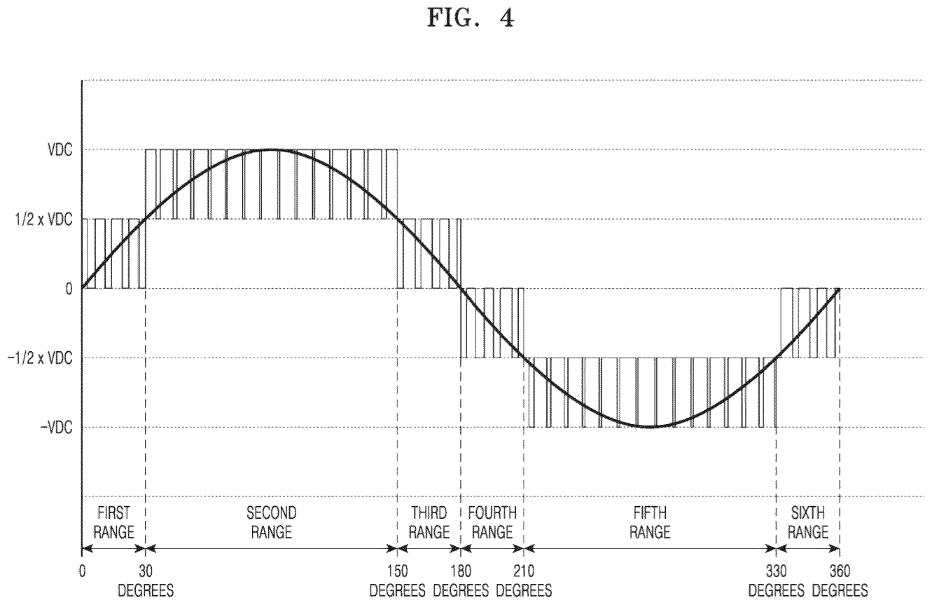

FIG. 4 shows an example of an alternating current voltage applied to the phase coil Lu according to one or more embodiments of the present disclosure.

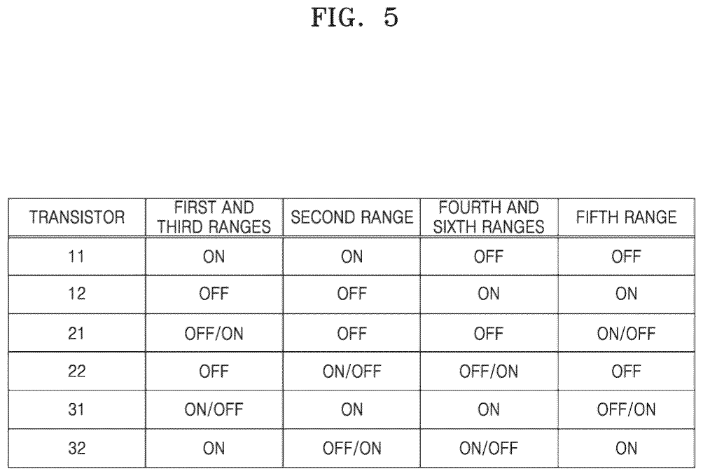

FIG. 5 shows an example of an ON/OFF state of each transistor in each angular range according to one or more embodiments of the present disclosure.

The processor of the controller 100 may control ON/OFF of the transistors 11 and 12 of the first inverter 10 and the transistors 21, 22, 31, and 32 of the second inverter 20, thereby applying a sinusoidal alternating current voltage to the phase coil Lu.

Hereinafter, among angular ranges within one period, a range of 0 degrees to 30 degrees is referred to as a first range, a range of 30 degrees to 150 degrees is referred to as a second range, a range of 150 degrees to 180 degrees is referred to as a third range, a range of 180 degrees to 210 degrees is referred to as a fourth range, a range of 210 degrees to 330 degrees is referred to as a fifth range, and a range of 330 degrees to 360 degrees is referred to as a sixth range.

As shown in FIG. 5, in the first range, after the processor of the controller 100 turns on the transistors 11 and 32 and simultaneously turns off the transistors 12 and 22, the processor of the controller 100 may repeatedly turn on any of the transistor 21 or 31 and turn off the other transistor. Accordingly, 1/2×VDC may be applied to the phase coil Lu at a timing of turning on the transistor 31 and turning off the transistor 21, and 0 V may be applied to the phase coil Lu at a timing of turning off the transistor 31 and turning on the transistor 21.

As shown in FIG. 5, in the second range, after the processor of the controller 100 turns on the transistors 11 and 32 and simultaneously turns off the transistors 12 and 22, the processor of the controller 100 may repeatedly turn on any of the transistor 22 or 32 and turn off the other transistor. Accordingly, VDC may be applied to the phase coil Lu at a timing of turning on the transistor 22 and turning off the transistor 32, and 1/2×VDC may be applied to the phase coil Lu at a timing of turning off the transistor 22 and turning on the transistor 32.

As shown in FIG. 5, in the third range, the processor of the controller 100 may control ON/OFF of the transistors 11 and 12 of the first inverter 10 and the transistors 21, 22, 31, and 32 of the second inverter 20, as in the first range. Accordingly, 1/2×VDC may be applied to the phase coil Lu at a timing of turning on the transistor 31 and turning off the transistor 21, and 0 V may be applied to the phase coil Lu at a timing of turning off the transistor 31 and turning on the transistor 21.

As shown in FIG. 5, in the fourth range, after the processor of the controller 100 turns on the transistors 12 and 31 and simultaneously turns off the transistors 11 and 21, the processor of the controller 100 may repeatedly turn on any of the transistor 22 or 32 and turn off the other transistor. Accordingly, −1/2×VDC may be applied to the phase coil Lu at a timing of turning on the transistor 32 and turning off the transistor 22, and 0 V may be applied to the phase coil Lu at a timing of turning off the transistor 32 and turning on the transistor 22.

As shown in FIG. 5, in the fifth range, after the processor of the controller 100 turns on the transistors 12 and 32 and simultaneously turns off the transistors 11 and 22, the processor of the controller 100 may repeatedly turn on any of the transistor 21 or 31 and turn off the other transistor. Accordingly, −VDC may be applied to the phase coil Lu at a timing of turning on the transistor 21 and turning off the transistor 31, and −1/2×VDC may be applied to the phase coil Lu at a timing of turning off the transistor 21 and turning on the transistor 31.

As shown in FIG. 5, in the sixth range, the processor of the controller 100 may control ON/OFF of the transistors 11 and 12 of the first inverter 10 and the transistors 21, 22, 31, and 32 of the second inverter 20, as in the fourth range. Accordingly, −1/2×VDC may be applied to the phase coil Lu at a timing of turning on the transistor 32 and turning off the transistor 22, and 0 V may be applied to the phase coil Lu at a timing of turning off the transistor 32 and turning on the transistor 22.

As such, the controller 100 may control ON/OFF of the transistors 11 and 12 of the first inverter 10 and the transistors 21, 22, 31, and 32 of the second inverter 20, thereby applying a sinusoidal alternating current voltage to the phase coil Lu.

Likewise, the processor of the controller 100 may control ON/OFF of the transistors 13 and 14 of the first inverter 10 and the transistors 23, 24, 33, and 34 of the second inverter 20, thereby applying a sinusoidal alternating current voltage to the phase coil Lv.

Also, the processor of the controller 100 may control ON/OFF of the transistors 15 and 16 of the first inverter 10 and the transistors 25, 26, 35, and 36 of the second inverter 20, thereby applying a sinusoidal alternating current voltage to the phase coil Lw.

However, the controller 100 may control ON/OFF of the transistors such that periods of the sinusoidal alternating current voltage applied to the phase coil Lu, the sinusoidal alternating current voltage applied to the phase coil Lv, and the sinusoidal alternating current voltage applied to the phase coil Lw are misaligned by ⅓ (phases are misaligned by 120 degrees).

As described above, the motor driver 1, which is a driver for the motor 1100 having the plurality of phase coils Lu, Lv, and Lw not connected to each other, may include the first inverter 10 and the second inverter 20 as examples of two inverters respectively connected to both ends of the plurality of phase coils Lu, Lv, and Lw and having a pair of transistors (for example, the transistors 11 and 12 and the transistors 21 and 22) for each phase coil. Also, the motor driver 1 may include the converter 50 that rectifies an alternating current voltage to convert the alternating current voltage into a direct current voltage, and the first capacitor 61 and the second capacitor 62 as examples of a plurality of capacitors that are connected in series between the output terminals of the converter 50 and divide a direct current voltage VDC between the corresponding output terminals. Also, the second inverter 20 as one of the two inverters may include the transistors 31, 32, 33, 34, 35, and 36 connected between an intermediate point of a pair of transistors (for example, the transistors 21 and 22) for each phase coil (for example, the phase coil Lu) and the intermediate potential node M of the direct current voltage VDC formed by the first capacitor 61 and the second capacitor 62.

As such, in the motor driver 1, by configuring one inverter of the two inverters respectively connected to both ends of the plurality of phase coils Lu, Lv, and Lw not connected to each other as a three-level inverter capable of outputting three levels of VDC, 1/2×VDC, and 0, a voltage waveform that is applied to the motor 1100 may become +1/2×VDC or ±VDC. Therefore, compared to a case in which a voltage waveform of ±VDC is applied to the motor 1100, an output voltage may become closer to a sine wave, thereby reducing loss of the motor 1100 and noise caused by ON and OFF switching of the transistors. Also, because a voltage applied during ON and OFF switching of the transistors is 1/2×VDC, switching loss may be reduced compared to a configuration in which a voltage applied during ON and OFF switching of transistors is VDC. As a result, inverter loss of the first inverter 10 and the second inverter 20 may be reduced.

Also, the motor driver 1 may include the controller 100 that controls the transistors 11, 12, 13, 14, 15, and 16 (examples of the first switching devices) and the transistors 21, 22, 23, 24, 25, and 26 (examples of the second switching devices) of the two inverters and the transistors 31, 32, 33, 34, 35, and 36 (examples of the third switching devices) of the second inverter 20 to switch a coil mode of the motor 1100 between the star connection mode and the open coil mode.

By the motor driver 1, because the processor of the controller 100 is capable of switching a coil mode through ON and OFF switching of the transistors of the two inverters, there may be no need to install a switch for switching a coil mode. Also, the motor driver 1 according to one or more embodiments of the present disclosure may switch a coil mode seamlessly compared to a configuration of switching a coil mode by using a switch.

The processor of the controller 100 may switch a coil mode according to a load of the motor 1100 in such a way as to control the motor 1100 to operate in the star connection mode in a low-speed operation region where a rotation speed of the motor 1100 is low and to operate in the open coil mode in a high-speed operation region where a rotation speed of the motor 1100 is high. A low-speed operation and a high-speed operation may be relative, but for example, when the motor 1100 according to one or more embodiments of the present disclosure operates at 0 rpm to 1800 rpm, a low-speed operation may correspond to a case in which the motor 1100 rotates at a lower speed than 600 rpm, and a case in which the motor 1100 rotates at a higher speed may correspond to a high-speed operation, but is not limited thereto. As another example, in the case of the motor 1100 rotating at 0 rpm to 3600 rpm, up to 1200 rpm may correspond to a low-speed operation, and a higher rpm may correspond to a high-speed operation. However, this is only an example, and, for example, 1500 rpm may be a boundary between a high-speed operation and a low-speed operation.

For example, when current Ia detected by the current detector 140 is less than or equal to a preset threshold value, the processor of the controller 100 may control the motor 1100 to operate in the star connection mode, and when current la detected by the current detector 140 exceeds the threshold value, the processor of the controller 100 may control the motor 1100 to operate in the open coil mode. Therefore, efficiency of the motor 1100 in the low-speed operation region may be raised, thereby increasing energy saving performance. In addition, because it is possible to increase an applied voltage in a high-speed driving region, an output of the motor 1100 may increase. Also, by setting the star connection mode in a low-speed operation region and the open coil mode in a high-speed operation region, there may be no need for a boosting circuitry of a power source, and because it is possible to increase an applied voltage in a high-speed operation region, it may be possible to increase the number of coils of the motor 1100. As a result, because it is possible to reduce current flowing through one coil, efficiency of the motor 1100 in the low-speed operation region may increase.

However, the processor of the controller 100 may not perform switching between the star connection mode and the open coil mode. For example, the processor of the controller 100 may set the open coil mode even in the low-speed operation region or set the open coil mode in all operation regions.

Also, in the above-described embodiment, the second inverter 20 includes the bidirectional switch portion 27, but, the present disclosure is not limited thereto. The first inverter 10, instead of the second inverter 20, may include the bidirectional switch portion 27 connected to one ends of the phase coils Lu, Lv, and Lw and the intermediate potential node M. Also, both the first inverter 10 and the second inverter 20 may include the bidirectional switch portion 27.

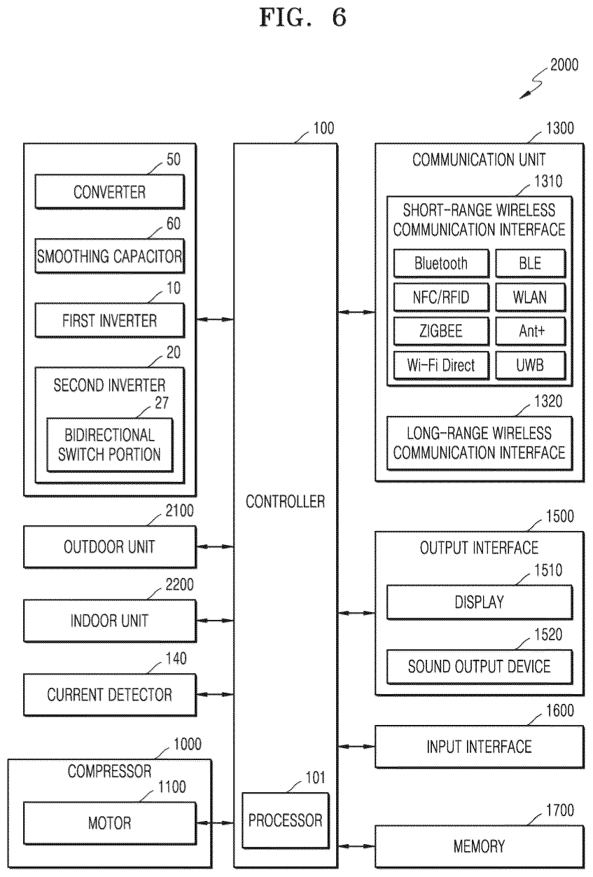

FIG. 6 is a block diagram of a motor driver in an air conditioner according to one or more embodiments of the present disclosure.

An air conditioner 2000 according to the block diagram of FIG. 6 may include the converter 50, the smoothing capacitor 60, the first inverter 10, and the second inverter 20, which are in charge of driving, the controller 100, a communication unit 1300, the output interface 1500, the input interface 1600, memory 1700, the current detector 140, the compressor 1000, the motor 1100 for the compressor 1000, the outdoor unit 2100, and the indoor unit 2200. All the components of the air conditioner 2000 may not be essential, and some of the components may be omitted or another component may be added according to a manufacturer's design concept.

Hereinafter, the components will be described in order.

The converter 50, the smoothing capacitor 60, the first inverter 10, and the second inverter 20, which are in charge of driving, may receive power from an external power source, and supply current to the motor 1100 used in the compressor 1000 according to a driving control signal from the controller 100.

The converter 50 may convert an alternating current voltage into a direct current voltage. For example, the converter 50 may convert an alternating current voltage of which a magnitude and polarity (positive voltage or negative voltage) change over time into a direct current voltage with a constant magnitude and polarity, and convert alternating current of which a magnitude and direction (positive current or negative current) change over time into direct current with a constant magnitude. The converter 50 may include a bridge diode. For example, the converter 50 may include four diodes. The bridge diode may convert an alternating current voltage of which polarity changes over time into a positive voltage with constant polarity, and convert alternating current of which a direction changes over time into positive current with a constant direction. In another embodiment, the converter 50 may include two diodes and two thyristors. One thyristor and one diode may configure one rectifier leg, and another thyristor and another diode may configure another rectifier leg. However, this may correspond to a case in which the input power source 40 is single-phase. When the input power source 40 is three-phase, the converter 50 including three legs may be configured with three thyristors and three diodes. The controller 100 may control the thyristors such that a voltage charged to the smoothing capacitor 60 increases gradually rather than abruptly.

The first inverter 10 and the secondi inverter 20 may control current that is supplied to the motor 1100. For example, a magnitude of current flowing through the motor 1100 may change according to turning on/off of the switching devices included in the first inverter 10 and the second inverter 20. In this case, alternating current may be supplied to the motor 1100. The second inverter may include the bidirectional switch portion 27 between a pair of switches corresponding to each of the plurality of phase coils Lu, Lv, and Lw included in the motor 1100 and the intermediate potential node which is an intermediate node at which the smoothing capacitor 60 is divided into two capacitors 61 and 62. The bidirectional switch portion 27 may include the plurality of third switching devices.

In one or more embodiments, the first inverter 10 may include a plurality of fourth switching devices between a pair of switches corresponding to each of the plurality of phase coils Lu, Lv, and Lw and the intermediate potential node of the smoothing capacitor 60.

The processor 101 of the controller 100 (generally referred to herein as “the processor of the controller” or “the processor”) may control overall operations of the air conditioner 2000 and/or the motor driver 1. The processor of the controller 100 may execute programs stored in the memory 1700 to control the first inverter 10, the second inverter 20, the communication unit 1300, the output interface 1500, the input interface 1600, the memory 1700, the outdoor unit 2100, and the indoor unit 2200. The processor may be a single or a plurality of processors. In this instance, the single or the plurality of processors may be a general-purpose processor such as a Central Processing Unit (CPU), an Application Processor (AP), or Digital Signal Processor (DSP), a graphics-specific processor such as a Graphics Processing Unit (GPU) or Vision Processing Unit (VPU), or an AI-specific processor such as a Neural Processing Unit (NPU).

In one or more embodiments, the processor of the controller 100 may control the first inverter 10 and the second inverter 20 to set a coil mode of the motor 1100 to the star connection mode in which one ends of the plurality of phase coils Lu, Lv, and Lw are connected to each other, or may control the first inverter 10 and the second inverter 20 for switching to the open coil mode in which three-phase alternating current is applied to the plurality of phase coils Lu, Lv, and Lw. In one or more embodiments, the processor of the controller 100 may control the plurality of phase coils Lu, Lv, and Lw to be set to the star connection mode by turning off all the switching devices of the second inverter 20 and turning on all the plurality of third switching devices of the bidirectional switch portion 27.

According to one or more embodiments of the present disclosure, the controller 100 may install an artificial intelligence (AI) processor therein. The AI processor may be manufactured in the form of a dedicated hardware chip for AI, or may be manufactured as a part of an existing general-purpose processor (e.g., central processing unit (CPU) or application processor) or a graphics-only processor (e.g., GPU) and mounted on the air conditioner 2000.

According to one or more embodiments of the present disclosure, the controller 100 may include the setting portion 110, the output portion 120, the speed detector 130, and the current detector 140. Accordingly, the current detector 140 of FIG. 6 is shown to be separated from the controller 100. However, the current detector 140 may be a component of the controller 100. The current detector 140 may be positioned on a path of current flowing from each coil of the motor 1100 to the first inverter 10 to obtain current (mainly, alternating current) information.

The controller 100 may include the communication unit 1300 to operate on an Internet of Things (IoT) network or a home network as necessary.

The communication unit 1300 may include a short-range wireless communication interface 1310 and a long-range wireless communication interface 1320. The short-range wireless communication interface 1310 may include a Bluetooth communication interface, a Bluetooth Low Energy (BLE) communication interface, a Near Field Communication (NFC) interface, a Wireless-Fidelity (Wi-Fi) communication interface, a Zigbee communication interface, an infrared Data Association (IrDA) communication interface, a Wi-Fi direct (WFD) communication interface, an Ultra Wideband (UWB) communication interface, an Ant+ communication interface, etc., although not limited thereto. The long-range wireless communication interface 1320 may receive/transmit a wireless signal from/to at least one of a base station, an external terminal, or a server on a mobile communication network. Herein, the wireless signal may include a voice call signal, a video call signal or various formats of data according to transmission/reception of text/multimedia messages. The long-range wireless communication interface 1320 may include a 3Generation (3G) module, a 4Generation (4G) module, a 5Generation (5G) module, a Long Term Evolution (LTE) module, a Narrowband Internet of Things (NB-IoT) module, a Long-Term Evolution for Machines (LTE-M), etc., although not limited thereto. According to one or more embodiments of the present disclosure, the air conditioner 2000 may communicate with an external server or another electrical device outside the air conditioner 2000 and transmit/receive data to/from the external server or the other electrical device through the communication unit 1300.

The output interface 2500 may be used to output an audio signal or a video signal, and may include a display 1510 and a sound output device 1520.

According to one or more embodiments of the present disclosure, the air conditioner 2000 may display information related to the air conditioner 2000 through the display 1510. For example, the air conditioner 2000 may display power factor information of the air conditioner 2000 or each harmonic component value (for example, percentage (%) or ampere (A) of each harmonic component with respect to input current).

When the display 1510 and a touch pad form a layer structure to be configured as a touch screen, the display 1510 may be used as an input device, as well as an output device. The display 1510 may include at least one of a liquid crystal display (LCD), a thin film transistor-liquid crystal display (TFT-LCD), a light-emitting diode (LED), an organic light-emitting diode (OLED), a flexible display, a 3Dimensional (3D) display, or an electrophoretic display. Also, according to an implementation type of the motor driver 1, two or more displays 1510 may be provided.

The sound output device 1520 may output audio data received from the communication unit 1300 or stored in the memory 1700. Also, the sound output device 1520 may output a sound signal related to a function that is performed in the air conditioner 2000. The sound output device 1520 may include a speaker, a buzzer, etc.

According to one or more embodiments of the present disclosure, the output interface 1500 may display at least one among power factor information of the air conditioner 2000, harmonic component information, whether regenerative braking is performed, or a charging rate of an energy storage device, through the display 1510. According to one or more embodiments of the present disclosure, the output interface 1500 may display a current power level, an operation mode (for example, a low-noise mode, a normal mode, a high-power mode, etc.), a current power factor, etc.

The input interface 1600 may be used to receive an input from a user. The input interface 1600 may include at least one of a key pad, a dome switch, a touch pad (a capacitive type, a resistive type, an infrared beam type, a surface acoustic wave type, an integral strain gauge type, a piezo effect type, etc.), a jog wheel, or a jog switch, although not limited thereto.

The input interface 1600 may include a voice recognition module. For example, the air conditioner 2000 may receive a voice signal which is an analog signal, through a microphone, and convert a voice part into computer-readable text by using an Automatic Speech Recognition (ASR) model. The air conditioner 2000 may obtain an intention of a user's utterance by interpreting the converted text through a Natural Language Understanding (NLU) model. Herein, the ASR model or NLU model may be an AI model. The AI model may be processed by an AI-dedicated processor designed as a hardware structure specialized for processing AI models. The AI model may be created through training. Herein, being created through training may be that a basic AI model is trained by a training algorithm using a large amount of learning data, thereby creating a pre-defined operation rule or AI model set to perform a desired characteristic (or purpose). The AI model may be configured with a plurality of neural network layers. Each of the plurality of neural network layers may have a plurality of weight values, and perform a neural network operation through computation between an operation result of a previous layer and the plurality of weight values.

Linguistic comprehension is technology for recognizing and applying/processing human language/characters, and includes Natural Language Processing, Machine Translation, Dialogue System, Question Answering, Speech Recognition/Synthesis, etc.

The memory 1700 may store a program for processing and control by the controller 100, and store input/output data (for example, power factor information of the air conditioner 2000, information about harmonic components, etc.). The memory 1700 may store an AI model.

The memory 1700 may include at least one type of storage medium among a flash memory type, a hard disk type, a multimedia card micro type, a card type memory (for example, Secure Digital (SD) or extreme Digital (XD) memory), Random Access Memory (RAM), Static Random Access Memory (SRAM), Read Only Memory (ROM), Electrically Erasable Programmable Read-Only Memory (EEPROM), Programmable Read-Only Memory (PROM), a magnetic memory, a magnetic disk, or an optical disk. Also, the air conditioner 2000 may operate a web storage or a cloud server that performs a storage function on the Internet.

The outdoor unit 2100, the indoor unit 2200, and the compressor 1000 have been described in detail with reference to FIGS. 1A and 1B, and therefore, detailed descriptions thereof will be omitted. The compressor 1000 may include the motor 1100 for compressing a refrigerant.

The motor 1100 may be a rotating body capable of being driven by an alternating current voltage, and rotate to perform washing, drying, cleaning, operations of the air conditioner, operations of a cooler, etc. Accordingly, the air conditioner 2000 of FIG. 6 may be applied in the same way to block diagrams of various home appliances using the motor 1100 and the motor driver 1, including a cleaner, a codeless cleaner, a washing machine, a dryer, and an electric fan (including a circulator). Accordingly, the block diagram of FIG. 6 may be applied to various home appliances, as well as the air conditioner 2000.

All the components shown in the air conditioner 2000 according to one or more embodiments of the present disclosure may not be essential components. The air conditioner 2000 may be implemented with more components than those shown or with less components than those shown. Throughout the present disclosure, an electric device including the motor driver 1 may be a home appliance sold independently or may be a device constituting a part of a home appliance.

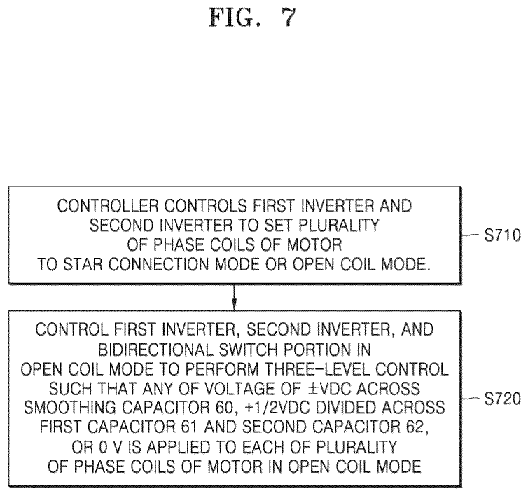

FIG. 7 is a flowchart of a motor driving method in an air conditioner according to one or more embodiments of the present disclosure.

In operation S710, the processor of the controller 100 may control the first inverter 10 and the second inverter 20 to set the plurality of phase coils of the motor 1100 to a star connection mode or an open coil mode. In one or more embodiments, the processor of the controller 100 may control the plurality of phase coils to be set to the star connection mode by turning off all the six transistors 21, 22, 23, 24, 25, and 26 of the second switching devices of the second inverter 20 and turning on all the transistors 31, 32, 33, 34, 35, and 36 of the bidirectional switch portion 27. In one or more embodiments, the processor of the controller 100 may control switching to the open coil mode by turning on only transistors corresponding to a phase coil to which a voltage is applied among the plurality of phase coils of the motor 1100, among the transistors 31, 32, 33, 34, 35, and 36 of the bidirectional switch portion 27. In one or more embodiments, when current flowing through the plurality of phase coils of the motor 1100 is less than or equal to a preset threshold value, the processor of the controller 100 may control the motor 1100 to operate in the star connection mode, and when current flowing through the plurality of phase coils of the motor 1100 exceeds the threshold value, the processor of the controller 100 may control the motor 1100 to operate in the open coil mode. Also, in one or more embodiments, the processor of the controller 100 may control the motor 1100 to operate in the star connection mode when the motor 1100 operates at a low speed, and when the motor 1100 operates at a high speed, the processor of the controller 100 may control the motor 1100 to operate in the open coil mode.

In operation S 720, the processor of the controller 100 may control the first inverter 10, the second inverter 20, and the bidirectional switch portion 27 in the open coil mode to perform three-level control such that any of a voltage of ±VDC across the smoothing capacitor 60, +1/2VDC divided across the first capacitor 61 and the second capacitor 62, or 0 V is applied to each of the plurality of phase coils in the open coil mode.

An air conditioner according to one or more embodiments of the present disclosure may include an outdoor heat exchange configured to perform heat exchange between a refrigerator and air, a compressor configured to intake and compress a refrigerant gas of the refrigerant, an expansion device configured to lower pressure and temperature of the refrigerant compressed during a heating or cooling operation, an outdoor unit including at least a portion of a refrigerant pipe connecting the compressor to the expansion device, a motor used in the compressor and including a plurality of phase coils, each of which is not connected to each other, and a motor driver configured to drive the motor and including a first inverter composed of a first switching device connected to a first end of each of the plurality of phase coils and including a pair of switches corresponding to each of the plurality of phase coils, a second inverter composed of a second switching device connected to a second end of each of the plurality of phase coils and including a pair of switches corresponding to each of the plurality of phase coils, a converter configured to rectify alternating current power and convert the alternating current power into direct current power, and a plurality of capacitors configured to divide a direct current voltage across output terminals of the converter, wherein the pair of switches corresponding to each of the plurality of phase coils and included in the second switching device is connected to an intermediate potential node at which the direct current voltage is divided.

According to one or more embodiments, the air conditioner may further include a processor configured to control the first switching device of the two inverters and the second switching device of one inverter to switch a coil mode of the motor to a star connection mode of connecting the plurality of phase coils to each other or an open coil mode of applying 3-phase alternating current to the plurality of phase coils by operating the two inverters in cooperation with each other.

The processor according to one or more embodiments may be configured to perform switching from the star connection mode to the open coil mode by converting an output voltage of one inverter from a neural point voltage which is a voltage at the intermediate potential node to a voltage required for a cooperation operation.

The processor according to one or more embodiments may be configured to, in the open coil mode, convert the output voltage of the one inverter to three levels of a direct current voltage, the neural point voltage which is the voltage at the intermediate potential node, and 0.

According to one or more embodiments, when 3-phase alternating current is applied to the plurality of phase coils by operating the two inverters in cooperation with each other, the output voltage of the one inverter may be converted to three levels of direct current power, the neural point voltage which is the voltage at the intermediate potential node, and 0.

The air conditioner according to one or more embodiments of the present disclosure may include an indoor unit including an indoor heat exchanger that performs heat exchange between a refrigerant and indoor air, and an outdoor unit including an outdoor heat exchanger that performs heat exchange between the refrigerant and outside air, a compressor that intakes a refrigerant gas of the refrigerant and compresses the refrigerant gas of the refrigerant, and an expansion device that lowers pressure and temperature of the refrigerant compressed during a cooling or heating operation. Also, the air conditioner may include a refrigerant pipe connecting the indoor heat exchanger, the outdoor heat exchanger, the compressor, and the expansion device to each other. The air conditioner according to one or more embodiments may include a motor having a plurality of phase coils not connected to each other and used in the compressor. The air conditioner according to one or more embodiments may include a first inverter composed of a first switching device connected to a first end of each of the plurality of phase coils and including a pair of switches corresponding to each of the plurality of phase coils, a second inverter composed of a second switching device connected to a second end of each of the plurality of phase coils and including a pair of switches corresponding to each of the plurality of phase coils, a converter configured to rectify alternating current power and convert the alternating current power into direct current power, and a plurality of capacitors configured to divide a direct current voltage across output terminals of the converter, wherein the pair of switches corresponding to each of the plurality of phase coils and included in the second switching device is connected to an intermediate potential node at which the direct current voltage is divided.

In one or more embodiments, the second inverter may include a plurality of third switching devices between the pair of switches corresponding to each of the plurality of phase coils and the intermediate potential node.

In one or more embodiments, the plurality of third switching devices may be devices capable of bidirectional switching.

In one or more embodiments, the first inverter may include a plurality of fourth switching devices between the pair of switches corresponding to each of the plurality of phase coils and the intermediate potential node.

In one or more embodiments, the air conditioner may further include a motor having a plurality of phase coils, and further include a processor configured to control the first inverter and the second inverter to switch a coil mode of the motor to a star connection mode in which one ends of the plurality of phase coils are connected to each other, or control the first inverter and the second inverter to switch a coil mode of the motor to an open coil mode of applying three-phase alternating current to the plurality of phase coils.

In one or more embodiments, the processor may be configured to control the plurality of phase coils to be set to the star connection mode by turning off the second switching device of the second inverter and turning on all of the plurality of third switching devices.

In one or more embodiments, the processor may be configured to control switching to the open coil mode by turning on only a switching device corresponding to a phase coil to which a voltage is applied among the plurality of phase coils, among the plurality of third switching devices, to connect the phase coil to which the voltage is applied among the plurality of phase coils to the intermediate potential node.

In one or more embodiments, in the open coil mode, the voltage applied to each of the plurality of phase coils may include a three-level voltage including a ±voltage level (±VDC) corresponding to a voltage across the plurality of capacitors, a ±1/2 voltage level (+1/2 VDC), and a 0 voltage level.

In one or more embodiments, a voltage applied to each of the plurality of phase coils may be 1/2×VDC in a first range of 0 degrees to 30 degrees and a third range of 150 degrees to 180 degrees in one period of a voltage applied to any one phase coil among the plurality of phase coils, the voltage may be VDC in a second range of 30 degrees to 150 degrees, the voltage may be −1/2×VDC in a fourth range of 180 degrees to 210 degrees and a sixth range of 330 degrees to 360 degrees, and the voltage may be −VDC in a fifth range of 210 degrees to 330 degrees.

In one or more embodiments, the pair of switches of the first switching device connected to the first end of a first coil among the plurality of phase coils may be an 11^{th} switch and a 12^{th} switch, the pair of switches of the second switching device connected to the second end of the first coil may be a 21^{st} switch and a 22^{nd} switch, and the third switching devices connected between the second end of the first coil and the intermediate potential node may be a 31^{st} switch and a 32^{nd} switch.

In one or more embodiments, the processor may be configured to perform control of turning on the 11^{th} switch and the 32^{nd} switch and turning off the 12^{th} switch and the 22^{nd} switch in the first range and the third range, turning on the 31^{st} switch when the 21^{st} switch is turned off, and turning off the 31^{st} switch when the 21^{st} switch is turned on.

In one or more embodiments, the processor may be configured to perform control of turning on the 11^{th} switch and the 31^{st} switch and turning off the 12^{th} switch and the 21^{st} switch in the second range, turning off the 32^{nd} switch when the 22^{nd} switch is turned on, and turning on the 32^{nd} switch when the 22^{nd} switch is turned off.

In one or more embodiments, the processor may be configured to perform control of turning on the 12^{th} switch and the 31^{st} switch and turning off the 11^{th} switch and the 21^{st} switch in the fourth range and the sixth range, turning on the 32^{nd} switch when the 22^{nd} switch is turned off, and turning off the 32^{nd} switch when the 22^{nd} switch is turned on.

In one or more embodiments, the processor may be configured to perform control of turning on the 12^{th} switch and the 32^{nd} switch and turning off the 11^{th} switch and the 22^{nd} switch in the fifth range, turning off the 31^{st} switch when the 21^{st} switch is turned on, and turning on the 31^{st} switch when the 21^{st} switch is turned off.

In one or more embodiments, the processor may be configured to perform control of, when current flowing through the plurality of phase coils is less than or equal to a preset threshold value, operating the motor in the star connection mode, and when current flowing through the plurality of phase coils exceeds the preset threshold value, operating the motor in the open coil mode.

In one or more embodiments, the processor may be configured to perform control of operating the motor in the star connection mode while the motor operates at a low speed and operating the motor in the open coil mode while the motor operates at a high speed.

A home appliance according to one or more embodiments of the present disclosure may include a motor including a plurality of phase coils each of which is not connected to each other, a first inverter composed of a first switching device connected to a first end of each of the plurality of phase coils and including a pair of switches corresponding to each of the plurality of phase coils, a second inverter composed of a second switching device connected to a second end of each of the plurality of phase coils and including a pair of switches corresponding to each of the plurality of phase coils, a converter configured to rectify alternating current power and convert the alternating current power into direct current power, and a plurality of capacitors configured to divide a direct current voltage across output terminals of the converter, wherein the pair of switches corresponding to each of the plurality of phase coils and included in the second switching device is connected to an intermediate potential node at which the direct current voltage is divided.

One or more embodiments of the present disclosure may be implemented in the form of a computer-readable recording medium including an instruction that is executable by a computer, such as a program module that is executed by a computer. The computer-readable recording medium may be an arbitrary available medium which can be accessed by a computer, and may include a volatile or non-volatile medium and a separable or non-separable medium. Further, the computer-readable recording medium may include a computer storage medium and a communication medium. The computer storage medium may include volatile and non-volatile media and separable and non-separable media implemented by an arbitrary method or technology for storing information such as a computer readable instruction, a data structure, a program module, or other data. The communication medium may generally include a computer readable instruction, a data structure, a program module, other data of a modulated data signal such as a carrier wave, or another transmission mechanism, and include an arbitrary information transmission medium.

Also, one or more embodiments of the present disclosure may be implemented as a computer program including instructions executable by a computer, such as a computer program that is executed by a computer, or as a computer program product.

The computer-readable storage media may be provided in a form of non-transitory storage media. Herein, the term ‘non-transitory storage medium’ means that it is a tangible device, and does not include a signal (e.g., an electromagnetic wave), but this term does not differentiate between where data is semi-permanently stored in the storage medium and where the data is temporarily stored in the storage medium. For example, a ‘non-transitory storage medium’ may include a buffer in which data is temporarily stored.

According to one or more embodiments of the disclosure, the method according to one or more embodiments of the present disclosure may be included and provided in a computer program product. The computer program product may be traded as a product between a seller and a buyer. The computer program product may be distributed in the form of a machine-readable storage medium (e.g., CD-ROM), or be distributed (e.g., downloadable or uploadable) online via an application store or between two user devices (e.g., smart phones) directly. When distributed online, at least a part of the computer program product (e.g., a downloadable app) may be temporarily generated or at least temporarily stored in a machine-readable storage medium, such as a memory of the manufacturer's server, a server of the application store, or a relay server.

What is claimed is:

1. An air conditioner comprising:
an outdoor heat exchange configured to perform heat exchange between a refrigerant and air;
a compressor configured to intake and compress a gaseous form of the refrigerant;
an expansion device configured to lower a pressure and a temperature of the refrigerant compressed during a heating operation or a cooling operation;
an outdoor unit comprising at least a portion of a refrigerant pipe connecting the compressor to the expansion device;
a motor configured to drive the compressor, the motor comprising a plurality of phase coils which are not connected to one another; and a motor driver configured to drive the motor, wherein the motor driver comprises:
a first inverter comprising a first switching device connected to a first end of each of the plurality of phase coils and comprising a pair of switches corresponding to each of the plurality of phase coils;
a second inverter comprising a second switching device connected to a second end of each of the plurality of phase coils and comprising a pair of switches corresponding to each of the plurality of phase coils;
a converter configured to rectify alternating current power and to convert the alternating current power into direct current power; and
a plurality of capacitors configured to divide a direct current voltage across output terminals of the converter,
wherein the pair of switches of the second switching device are connected to an intermediate potential node at which the direct current voltage is divided.

2. The air conditioner of claim 1, wherein the second inverter further comprises a plurality of third switching devices between the pair of switches of the second switching device and the intermediate potential node.

3. The air conditioner of claim 2, wherein each of the plurality of third switching devices are configured to perform bidirectional switching.

4. The air conditioner of claim 1, wherein the first inverter further comprises a plurality of fourth switching devices between the pair of switches of the first switching device and the intermediate potential node.

5. The air conditioner of claim 1, further comprising:
memory storing one or more instructions; and
at least one processor configured to execute the one or more instructions, wherein the one or more instructions, when executed by the at least one processor, cause the air conditioner to:
control the first inverter and the second inverter to switch a coil mode of the motor to a star connection mode wherein respective first ends of the plurality of phase coils are connected to each other, and
control the first inverter and the second inverter to switch the coil mode of the motor to an open coil mode wherein three-phase alternating current is applied to the plurality of phase coils.

6. The air conditioner of claim 5, wherein the second inverter further comprises a plurality of third switching devices between the pair of switches of the second switching device and the intermediate potential node, and
wherein the one or more instructions, wherein the one or more instructions, when executed by the at least one processor, cause the air conditioner to control the plurality of phase coils to be set to the star connection mode by turning off the second switching device and turning on all of the plurality of third switching devices.

7. The air conditioner of claim 5, wherein the second inverter further comprises a plurality of third switching devices between the pair of switches of the second switching device and the intermediate potential node, and
wherein the one or more instructions, wherein the one or more instructions, when executed by the at least one processor, cause the air conditioner to control switching to the open coil mode by turning on only a switching device among the plurality of third switching devices corresponding to a phase coil to which a voltage is applied among the plurality of phase coils, and thereby connect the phase coil to which the voltage is applied to the intermediate potential node.

8. The air conditioner of claim 5, wherein the one or more instructions, wherein the one or more instructions, when executed by the at least one processor, cause the air conditioner to, based on the first inverter and the second inverter being in the open coil mode, apply a three-level voltage to each of the plurality of phase coils, wherein the three-level voltage comprises a ±the direct current voltage level (±VDC) corresponding to a voltage across the plurality of capacitors, a ±1/2 of the direct current voltage (+1/2 VDC), and a 0 voltage level.

9. The air conditioner of claim 8, wherein a voltage applied to each of the plurality of phase coils, in one period of a voltage applied to any one phase coil among the plurality of phase coils, is a voltage of the intermediate potential node (1/2×VDC) in a first range of 0 degrees to 30 degrees and a third range of 150 degrees to 180 degrees, is VDC in a second range of 30 degrees to 150 degrees, is −1/2×VDC in a fourth range of 180 degrees to 210 degrees and a sixth range of 330 degrees to 360 degrees, and is −VDC in a fifth range of 210 degrees to 330 degrees.

10. The air conditioner of claim 9, wherein the second inverter further comprises a plurality of third switching devices between the pair of switches of the second switching device and the intermediate potential node,
wherein the pair of switches of the first switching device comprise an 11^{th} switch and a 12^{th} switch,
wherein the pair of switches of the second switching device comprise a 21^{st} switch and a 22^{nd} switch, and
wherein the plurality of third switching devices connected comprise a 31^{st} switch and a 32^{nd} switch.

11. The air conditioner of claim 10, wherein the one or more instructions, wherein the one or more instructions, when executed by the at least one processor, cause the air conditioner to:
turn on the 11^{th} switch and the 32^{nd} switch and turn off the 12^{th} switch and the 22^{nd} switch in the first range and the third range,
turn on the 31^{st} switch when the 21^{st} switch is turned off, and
turn off the 31^{st} switch when the 21^{st} switch is turned on.

12. The air conditioner of claim 10, wherein the one or more instructions, wherein the one or more instructions, when executed by the at least one processor, cause the air conditioner to:
turn on the 11^{th} switch and the 31^{st} switch and turn off the 12^{th} switch and the 21^{st} switch in the second range,
turn off the 32^{nd} switch when the 22^{nd} switch is turned on, and
turn on the 32^{nd} switch when the 22^{nd} switch is turned off.

13. The air conditioner of claim 10, wherein the one or more instructions, wherein the one or more instructions, when executed by the at least one processor, cause the air conditioner to:
turn on the 12^{th} switch and the 31^{st} switch and turn off the 11^{th} switch and the 21^{st} switch in the fourth range and the sixth range,
turn on the 32^{nd} switch when the 22^{nd} switch is turned off, and
turn off the 32^{nd} switch when the 22^{nd} switch is turned on.

14. The air conditioner of claim 10, wherein the one or more instructions, wherein the one or more instructions, when executed by the at least one processor, cause the air conditioner to:
turn on the 12^{th} switch and the 32^{nd} switch and turn off the 11^{th} switch and the 22^{nd} switch in the fifth range,
turn off the 31^{st} switch when the 21^{st} switch is turned on, and
turn on the 31^{st} switch when the 21^{st} switch is turned off.

15. The air conditioner of claim 5, wherein the one or more instructions, wherein the one or more instructions, when executed by the at least one processor, cause the air conditioner to:
based on current flowing through the plurality of phase coils being less than or equal to a preset threshold value, operate the motor in the star connection mode, and
based on current flowing through the plurality of phase coils exceeding the preset threshold value, operate the motor in the open coil mode.

16. The air conditioner of claim 5, wherein the one or more instructions, wherein the one or more instructions, when executed by the at least one processor, cause the air conditioner to:
based on the motor operating at or below a threshold speed, operate the motor in the star connection mode, and
based on the motor operating above the threshold speed, operating the motor in the open coil mode.
